(19) United States
(12) Patent Application Publication
(10) Pub. No.: US 2013/0095141 A1
(43) Pub. Date: Apr. 18, 2013

(54) FOOD GRADE DRY FILM COATING COMPOSITION AND METHODS OF MAKING AND USING THE SAME

(71) Applicants: Beverly A. Schad, Stoughton, WI (US); Eric Van Ness, St. Louis, MO (US)

(72) Inventors: Beverly A. Schad, Stoughton, WI (US); Eric Van Ness, St. Louis, MO (US)

(21) Appl. No.: 13/583,683

(22) PCT Filed: Mar. 8, 2011
(86) PCT No.: PCT/US11/27600

§ 371 Date: Dec. 26, 2012

Related U.S. Application Data
(60) Provisional application No. 61/311,505, filed on Mar. 8, 2010.

(51) Int. Cl. C09D 101/04

(52) U.S. Cl. CPC C09D 101/04
USPC 424/400; 106/203.2; 47/57.6; 426/89

(57) ABSTRACT

A dry film coating composition comprising a cellulose film former, an oligofructose fiber, a plasticizing agent, and a processing aid is disclosed herein. Also provided is a film coating suspension comprising a cellulose film former, an oligofructose fiber, a plasticizing agent, a processing aid, and a solvent. The film coating suspension may be applied to a substrate, such as, for example, nutritional supplements, pharmaceuticals, tablets, capsules, softgels, granules, particles (e.g., micro- and nano-particles), agricultural seeds, and the like to form a dry film coating on the substrate. Methods of coating a substrate with the film coating suspensions are also provided.

### CROSS REFERENCE TO RELATED APPLICATIONS

This application claims priority under 35 U.S.C. §119(e) to U.S. Provisional Patent Application No. 61/311,505, filed on Mar. 8, 2010, the contents of which are hereby incorporated by reference in their entirety.

### BACKGROUND

Film coating is an effective way of providing physical and chemical protection for a substrate. Film coatings include film forming agents—generally polymers that are soluble or dispersible in a solvent. Various additives may be used to facilitate the coating process and/or obtain specific coating properties. Ideally, film coatings should be stable, economical, and easy to process and should use food-approved ingredients to facilitate commercial implementation.

### SUMMARY

In an aspect, a dry film coating composition is provided. The dry film coating composition, in some embodiments, may comprise a cellulose film former, an oligofructose fiber, a plasticizing agent, and a processing aid.

In another aspect, the disclosure provides a film coating suspension comprising a cellulose film former, an oligofructose fiber, a plasticizing agent, a processing aid, and a solvent.

In another aspect, the disclosure provides a substrate coated with a dry film coating, where the dry film coating comprises a cellulose film former, an oligofructose fiber, a plasticizing agent, and a processing aid.

In another aspect, the disclosure provides a method of coating a substrate comprising applying a film coating suspension to a substrate to form a dry film coating thereon, where the film coating suspension comprises a cellulose film former, an oligofructose fiber, a plasticizing agent, a processing aid, and a solvent.

Other aspects and embodiments of the disclosure will become apparent to one of skill in the art in light of the following description.

### BRIEF DESCRIPTION OF THE DRAWINGS

FIG. 1 depicts film adhesion of a traditional HPMC coating and a dry film coating produced according to Example 3.

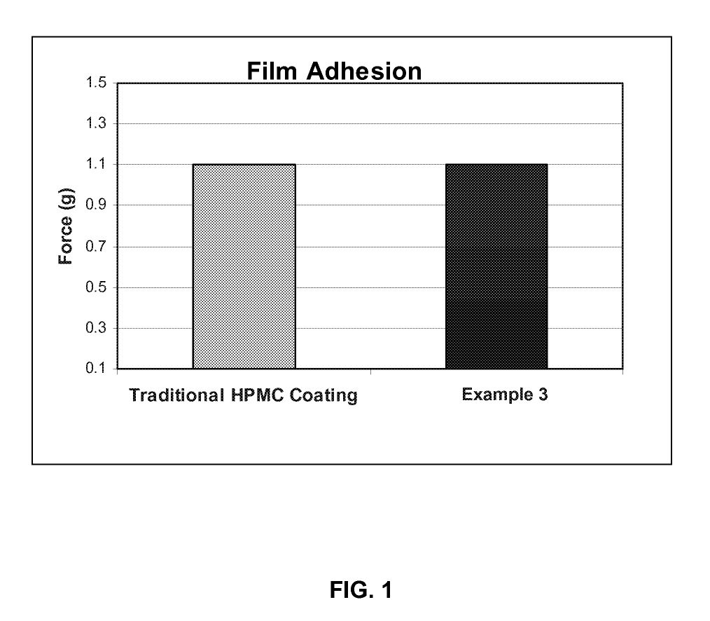

FIG. 2 depicts slip measured using a tablet substrate coated with a traditional HPMC coating and a tablet coated with a dry film coating produced according to Example 3. Slip is expressed in g tension force required to move a non-friction gliding object in contact with the coating.

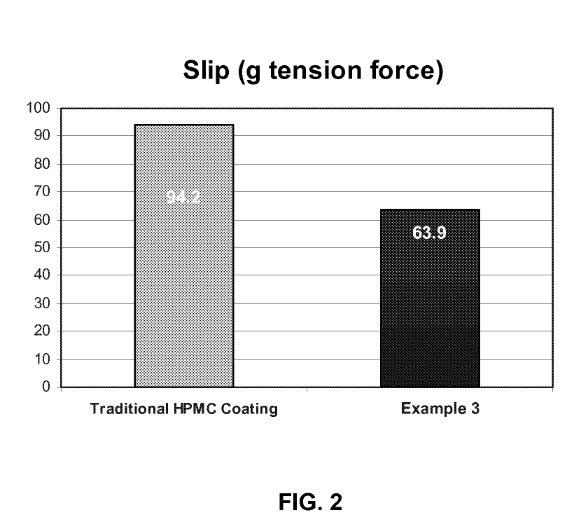

FIG. 3 depicts gloss measurements obtained using a tablet substrate coated with a traditional HPMC coating and with a film coating produced according to Example 3.

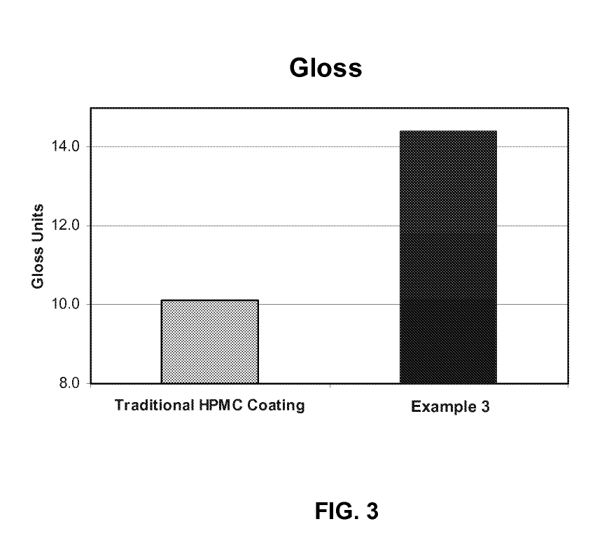

### DETAILED DESCRIPTION

The present disclosure is not limited to the specific details of construction, arrangement of components, or method steps set forth herein. The compositions and methods disclosed herein are capable of being made, practiced, used, carried out and/or formed in various ways that will be apparent to one of skill in the art in light of the disclosure that follows. The phraseology and terminology used herein is for the purpose of description only and should not be regarded as limiting to the scope of the claims. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to facilitate the disclosure and does not imply any limitation on the scope of the disclosure unless otherwise claimed. No language in the specification, and no structures shown in the drawings, should be construed as indicating that any non-claimed element is essential to the practice of the disclosed subject matter. The use herein of the terms “including,” “comprising,” or “having,” and variations thereof, is meant to encompass the elements listed thereafter and equivalents thereof, as well as additional elements.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like. All percentages referring to amounts are by weight unless indicated otherwise.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

In an aspect, the disclosure provides affordable, immediate-release, and easy-to-use coatings that meet FDA regulations as an alternative to coatings based on polyvinyl alcohol technology. In some embodiments, the disclosed compositions, suspensions, and coatings may be used in coating substrates such as, for example, nutritional supplements, pharmaceuticals, tablets, capsules, softgels, granules, particles (e.g., micro- and nano-particles), agricultural seeds, and the like. In embodiments, the dry film coating compositions may comprise at least one of a cellulose film former, an oligofructose fiber, a plasticizing agent, a processing aid, a slip aid, a detackifier, a lubricant, an opacifier, a colorant, a surfactant, a buffering agent, and combinations thereof. For example, in some embodiments, the dry film coating composition may comprise a cellulose film former, an oligofructose fiber, a plasticizing agent, and a slip aid. At least one of these materials may be approved for food use. When mixed with one or more solvents, the dry film coating composition may form a film coating suspension. The disclosed film coating suspensions may have high solution solids content, low viscosity, low foam, low heavy metals content, and/or low lead content. When applied to a substrate, the film coating suspensions may form a dry film coating. The disclosed dry film coatings may possess one or more of the following characteristics: high slip, high gloss, low heavy metals content, low lead content, and/or high color stability. Suitably, the disclosed dry film coating compositions, film coating suspensions and dry film coatings may be stable, economical, and easy to use, offering simple, rapid, and efficient processing.

A cellulose film former may include a molecule comprising at least one cellulose polymer or derivative modified with small amounts of propylene glycol ether groups attached to the cellulose anhydroglucose chain affording binding properties that enhance the reinforcing film properties of film applications. Cellulose film formers may provide smooth, clear, film-forming coating suspensions and enhance the rheological mechanical strength properties of dry film coating gel matrices. Examples of cellulose film formers include, but are not limited to, hydroxypropyl methyl cellulose (“HPMC”), carboxymethyl cellulose (“CMC”) or salts thereof, hydroxypropyl cellulose (“HPC”), methylcellulose (“MC”), hydroxyethyl cellulose (“HEC”), methylethyl cellulose (“MEC”), and the like. A variety of examples of commercially available cellulose film formers exist and may include, for example, Spectracel™ HPMC compositions (available from Sensient Technologies).

An oligofructose fiber may include any oligosaccharide that includes one or more fructose molecules. Examples of oligofructose fibers include, but are not limited to, inulin, oligofructose, fructooligosaccharides, and combinations thereof. Inulin, oligofructose, and fructooligosaccharides are oligosaccharide molecules composed of fructose units linked by β (2-1) bonds and often terminated by a glucose unit. Oligofructose fibers may be obtained using any suitable method and/or source. For example, some embodiments provide for oligofructose fibers that can be derived from natural sources such as chicory, garlic, asparagus, onion, leek, banana, and Jerusalem artichoke. In some embodiments, oligofructose and fructooligosaccharide molecules may be obtained by partial enzymatic hydrolysis of inulin. Examples of commercially available oligofructose fibers include, for example, Orafti® P95, Orafti® HSI, and Orafti® L58 Organic (available from BENEO, Inc.). Embodiments of the disclosure provide oligofructose fibers in amounts that allow production of film coating suspensions with high solids content and low viscosity.

Plasticizing agents may enhance the film characteristics of the dry film coating, such as adhesion, flexibility, permeability, and the like. In embodiments, plasticizing agents may include medium chain triglycerides, fatty acids, fatty acid derivatives, and combinations thereof. In some embodiments, examples of plasticizing agents may include, but are not limited to, propylene glycol dicaprylate/dicaprate, medium chain triglycerides (e.g., fractionated coconut oil), glyceryl monostearate, propylene glycol, polypropylene glycol, polyethylene glycol, triacetin, glycerin, dibutyl sebacate, triglycerides, acetylated monoglycerides, glycerol monstearates, glycerin monostearate, oleic acid, stearic acid, sorbitol, tributyl citrate, acetyltributyl citrate, dibutyl phthalate, triethyl citrate, triethanolamine, aqueous emulsions of glyceryl monostearate and triethyl citrate, and combinations thereof. Commercially available examples of propylene glycol dicaprylate/dicaprate include, for example, Miglyol® 840 (available from Sasol GmbH) and Neobee® M-20 (available from Stepan Co.).

Processing aids may improve coating process parameters or optical or mechanical film performance, enhancing film functionality and quality. Examples of processing aids include, but are not limited to, talc, calcium carbonate, clay, ammonium chloride, silica, sodium sulfate, calcium phosphate, propylene glycol dicaprylate/dicaprate, medium chain triglycerides (e.g., fractionated coconut oil), glyceryl monostearate, propylene glycol, polypropylene glycol, polyethylene glycol, triacetin, glycerin, dibutyl sebacate, triglycerides, acetylated monoglycerides, glycerol monstearates, glycerin monostearate, oleic acid, stearic acid, sorbitol, tributyl citrate, acetyltributyl citrate, dibutyl phthalate, triethyl citrate, triethanolamine, aqueous emulsions of glyceryl monostearate and triethyl citrate, and combinations thereof.

Slip aids may increase surface-to-surface tablet contact, aiding in coating uniformity from tablet-to-tablet interfacial contact during the coating process. The final tablet slip also aids in esophageal transit. Examples of slip aids include, but are not limited to, talc, natural and synthetic waxes, metal stearates, silica, natural and synthetic oils, fatty acids, and triglycerides.

Detackifiers may inhibit formation of collective particles and facilitate coalescence during film formation and at minimum film temperatures. Examples of detackifiers include, but are not limited to, talc, aluminum hydrate, acetylated glycerides, diglycerides, acetylated monoglyceride, polyvinylpyrrolidone, sorbitan monostearate, polyglycerol esters, ethyl acetate, glyceryl monostearate, monoglycerides, poloxamers, stearic acid, triacetin, triethyl citrate, mineral oil, kaolin, and combinations thereof.

Lubricants may enhance esophageal transit ease, film slipperiness, and surface flowability. Examples of lubricants include, but are not limited to, talc, metallic stearates, silicon dioxide, sodium stearyl fumarate, palmitic acid, fatty acid esters, fatty acids, fatty alcohols, mineral oil, paraffins, leucine, polyethylene glycols, metallic lauryl sulfates, stearic acid, hydrogenated vegetable oil, triethyl citrate, PEG 3350, and combinations thereof.

Opacifiers may impart dispersed fine particles in dry film coatings, providing opaque films with high optical densities. Examples of opacifiers include, but are not limited to, titanium dioxide, zinc oxide, and talc.

Examples of colorants include dyes, lakes, and pigments and may include, but are not limited to, titanium dioxide, iron oxides, dyes such as, for example, FD&C Lakes, Carmine Lake, FD&C Blue no. 1, FD&C Red no. 3, FD&C Red no. 40, FD&C Yellow no. 5, FD&C Yellow no. 6, FD&C Green no. 3, alumina, talc, annatto extract, calcium carbonate, canthaxanthin, caramel, β-carotene, carmine, dihydroxyacetone, tumeric oleoresin, cochineal extract, gardenia yellow, gardenia blue, beet powder, grape skin extract, riboflavin, purple sweet potato, red sweet potato, chlorophyll-containing extracts, pearlescent pigments, SensiPearl™ Blue, Silver, and Bright Silver (available from Sensient Colors, Inc.), natural colorants, and the like. Other examples of colorants are found in 21 C.F.R. §§73 and 74, which are hereby fully incorporated by reference.

Surfactants may function as wetting agents, lowering surface tension and interfacial tension and facilitating film coalescence. Examples of surfactants include, but are not limited to, polysorbates (polyethoxylated sorbitan fatty acid derivatives) such as, for example, polysorbate 80; polyglyceryl 10 laurate; lecithins; mono- and di-glycerides; propylene glycol; sodium lauryl sulfate; acetylated monoglycerides; additives of propyl gallate and citric acid and stabilizers therein; alcohol; alkali metal and ammonium salts of ethylene diamine tetracetic acid, nitrilo triacetic acid, citric acid, phosphoric acid, tartaric acid, glycolic acid, malic acid, lactic acid, acetic acid, and benzoic acid; and combinations thereof.

Buffering agents may impart anionic/cationic ratios of minerals of sodium, potassium, magnesium, and/or calcium. Examples of buffering agents include, but are not limited to, citric acid and sodium citrate. Suitable buffering agents can be selected based on the particular formulation and/or application (e.g., based on requirements of composition elements such as, for example, pharmaceutical actives, and/or route of administration).

Examples of solvents may include, but are not limited to, ethanol, water, and combinations thereof.

In an aspect, the disclosure provides a dry film coating composition. In some embodiments, the dry film coating composition may include at least about 20%, at least about 21%, at least about 22%, at least about 23%, at least about 24%, at least about 25%, at least about 26%, at least about 27%, at least about 28%, at least about 29%, at least about 30%, at least about 35%, and at least about 40% cellulose film former. The dry film coating composition may include less than about 90%, less than about 80%, less than about 70%, less than about 60%, less than about 55%, less than about 52%, less than about 50%, less than about 45%, less than about 42%, less than about 40%, less than about 35%, and less than about 30% cellulose film former. This includes, for example, about 20% to about 90%, about 25% to about 52%, and about 28% to about 42% cellulose film former. In some embodiments, the cellulose film former may comprise, for example, HPMC and/or CMC.

In some embodiments, the dry film coating composition may include at least about 1%, at least about 2%, at least about 3%, at least about 4%, at least about 5%, at least about 6%, at least about 7%, at least about 8%, at least about 9%, at least about 10%, at least about 15%, or at least about 20% oligofructose fiber. The dry film coating composition may include less than about 50%, less than about 40%, less than about 30%, less than about 20%, less than about 12%, less than about 11%, less than about 10%, less than about 9%, less than about 8%, less than about 7%, less than about 6%, and less than about 5% oligofructose fiber. This includes, for example, about 1% to about 50%, about 4% to about 12%, and about 4% to about 10% oligofructose fiber. In some embodiments, the oligofructose fiber may comprise, for example, inulin.

In some embodiments, the dry film coating composition may include at least about 3%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, and at least about 20% plasticizing agent. The dry film coating composition may include less than about 30%, less than about 25%, less than about 24%, less than about 23%, less than about 22%, less than about 21%, less than about 20%, less than about 19%, and less than about 18% plasticizing agent. This includes, for example, about 3% to about 30%, about 6% to about 25%, and about 10% to about 22% plasticizing agent. In some embodiments, the plasticizing agent may comprise, for example, glycerin, propylene glycol dicaprylate/dicaprate and/or medium chain triglycerides.

In some embodiments, the dry film coating composition may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% lubricant. The dry film coating composition may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% lubricant. This includes about 5% to about 35%, about 5% to about 30%, and about 8% to about 30% lubricant.

In some embodiments, the dry film coating composition may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% slip aid. The dry film coating composition may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% slip aid. This includes about 5% to about 35%, about 5% to about 30%, and about 8% to about 30% slip aid.

In some embodiments, the dry film coating composition may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% detackifier. The dry film coating composition may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% detackifier. This includes about 5% to about 35%, about 5% to about 30%, and about 8% to about 30% detackifier.

In some embodiments, the dry film coating composition may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% processing aid. The dry film coating composition may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% processing aid. This includes about 5% to about 35%, about 5% to about 30%, and about 8% to about 30% processing aid.

In some embodiments, the dry film coating composition may include at least about 1%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, and at least about 20% opacifier. The dry film coating composition may include less than about 30%, less than about 25%, less than about 24%, less than about 23%, less than about 22%, less than about 21%, less than about 20%, less than about 15%, and less than about 10% opacifier. This includes, for example, about 1% to about 30%, about 5% to about 25%, and about 5% to about 20% opacifier.

In some embodiments, the dry film coating composition may include at least about 0.05%, at least about 0.06%, at least about 0.07%, at least about 0.08%, at least about 0.09%, at least about 1%, at least about 2%, at least about 3%, at least about 4%, at least about 5%, at least about 10%, and at least about 15% colorant. The dry film coating composition may include less than about 30%, less than about 25%, less than about 20%, less than about 15%, less than about 10%, less than about 5%, less than about 1%, and less than about 0.1% colorant. This includes, for example, about 0.05% to about 30%, about 0.05% to about 25%, and about 0.1% to about 20% colorant.

In some embodiments, dry film coating composition may include at least about 0.1%, at least about 0.5%, at least about 1%, at least about 2%, at least about 3%, at least about 4%, at least about 5%, at least about 6%, at least about 7%, at least about 8%, at least about 9%, and at least about 10% surfactant. The dry film coating composition may include less than about 10%, less than about 9%, less than about 8%, less than about 7%, less than about 6%, less than about 5%, less than about 4%, less than about 3%, less than about 2%, and less than about 1% surfactant. This includes, for example, about 0.1% to about 10%, about 1% to about 6%, and about 1% to about 4% surfactant.

In some embodiments, the dry film coating composition may include at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, and at least about 5% buffering agent. The dry film coating composition may include less than about 10%, less than about 9%, less than about 8%, less than about 7%, less than about 6%, less than about 5%, less than about 4%, less than about 3%, less than about 2%, and less than about 1% buffering agent. This includes, for example, about 0.1% to about 10%, 1% to about 6%, and about 2% to about 5%, about 0.1% to about 0.5%, about 0.1% to about 0.4%, and about 0.1% to about 0.35% buffering agent.

In some embodiments, the dry film coating composition may include at least about 0%, at least about 1%, at least about 2%, at least about 3%, at least about 4%, and at least about 5% water. The dry film coating composition may include less than about 7%, less than about 6%, less than about 5%, less than about 4%, less than about 3%, less than about 2%, and less than about 1% water. This includes, for example, about 0% to about 5%, and about 1% to about 4% water. In some embodiments comprising an amount of water, the water may prehydrate one or more components of the coating composition (e.g., in order to aid dispersion, mixing, and/or formulation, such as, for example, when the dry film coating composition comprises a colorant comprising at least one lake). In some such embodiments, the water may be added to the dry film coating composition before addition of a plasticizing agent.

In an aspect, the disclosure provides a film coating suspension. In some embodiments, the film coating suspension may include at least about 3%, at least about 4%, at least about 5%, at least about 6%, at least about 7%, at least about 8%, at least about 9%, at least about 10%, at least about 11%, at least about 12%, at least about 13%, at least about 14%, and at least about 15% cellulose film former. The film coating suspension may include less than about 15%, less than about 14%, less than about 13%, less than about 12%, less than about 11%, less than about 10%, less than about 9%, less than about 8%, less than about 7%, less than about 6%, and less than about 5% cellulose film former. This includes, for example, about 3% to about 15%, about 5% to about 12%, and about 6% to about 11% cellulose film former. In some embodiments, the cellulose film former may comprise, for example, HPMC and/or CMC.

In some embodiments, the film coating suspension may include at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, and at least about 10% oligofructose fiber. The film coating suspension may include less than about 15%, less than about 14%, less than about 13%, less than about 12%, less than about 11%, less than about 10%, less than about 9%, less than about 8%, less than about 7%, less than about 6%, less than about 5%, and less than about 4% oligofructose fiber. This includes, for example, about 0.2% to about 15%, about 0.5% to about 10%, and about 1% to about 6% oligofructose fiber. In some embodiments, the oligofructose fiber may comprise, for example, inulin.

In some embodiments, the film coating suspension may include at least about 0%, at least about 1%, at least about 2%, at least about 3%, at least about 4%, at least about 5%, at least about 6%, at least about 7%, at least about 8%, at least about 9%, and at least about 10% plasticizing agent. The film coating suspension may include less than about 10%, less than about 9%, less than about 8%, less than about 7%, less than about 6%, less than about 5%, less than about 4%, less than about 3%, less than about 2%, and less than about 1% plasticizing agent. This includes, for example, about 0% to about 8%, about 1% to about 6%, and about 2% to about 4% plasticizing agent. In some embodiments, the plasticizing agent may comprise, for example, glycerin, propylene glycol dicaprylate/dicaprate and/or medium chain triglycerides.

In some embodiments, the film coating suspension may include at least about 0%, at least about 1%, at least about 2%, at least about 3%, at least about 4%, at least about 5%, at least about 6%, at least about 7%, at least about 8%, at least about 9%, and at least about 10% processing aid. The film coating suspension may include less than about 10%, less than about 9%, less than about 8%, less than about 7%, less than about 6%, less than about 5%, less than about 4%, less than about 3%, less than about 2%, and less than about 1% processing aid. This includes, for example, about 0% to about 10%, about 2% to about 8%, and about 4% to about 6% processing aid.

In some embodiments, the film coating suspension may include at least about 0%, at least about 1%, at least about 2%, at least about 3%, at least about 4%, at least about 5%, at least about 6%, at least about 7%, at least about 8%, at least about 9%, and at least about 10% slip aid. The film coating suspension may include less than about 10%, less than about 9%, less than about 8%, less than about 7%, less than about 6%, less than about 5%, less than about 4%, less than about 3%, less than about 2%, and less than about 1% slip aid. This includes, for example, about 0% to about 10%, about 2% to about 8%, and about 4% to about 6% slip aid.

In some embodiments, the film coating suspension may include at least about 0%, at least about 1%, at least about 2%, at least about 3%, at least about 4%, at least about 5%, at least about 6%, at least about 7%, at least about 8%, at least about 9%, and at least about 10% detackifier. The film coating suspension may include less than about 10%, less than about 9%, less than about 8%, less than about 7%, less than about 6%, less than about 5%, less than about 4%, less than about 3%, less than about 2%, and less than about 1% detackifier. This includes, for example, about 0% to about 10%, about 2% to about 8%, and about 4% to about 6% detackifier.

In some embodiments, the film coating suspension may include at least about 0%, at least about 1%, at least about 2%, at least about 3%, at least about 4%, at least about 5%, at least about 6%, at least about 7%, at least about 8%, at least about 9%, and at least about 10% lubricant. The film coating suspension may include less than about 10%, less than about 9%, less than about 8%, less than about 7%, less than about 6%, less than about 5%, less than about 4%, less than about 3%, less than about 2%, and less than about 1% lubricant. This includes, for example, about 0% to about 10%, about 2% to about 8%, and about 4% to about 6% lubricant.

In some embodiments, the film coating suspension may include at least about 0%, at least about 1%, at least about 2%, at least about 3%, at least about 4%, at least about 5%, at least about 6%, at least about 7%, and at least about 8% opacifier. The film coating suspension may include less than about 8%, less than about 7%, less than about 6%, less than about 5%, less than about 4%, less than about 3%, less than about 2%, and less than about 1% opacifier. This includes, for example, about 0% to about 8%, about 3% to about 6%, and about 3% to about 5% opacifier.

In some embodiments, the film coating suspension may include at least about 0%, at least about 0.01%, at least about 0.05%, at least about 0.1%, at least about 0.5%, at least about 1%, and at least about 5% colorant. The film coating suspension may include less than about 6%, less than about 5%, less than about 1%, less than about 0.5%, and less than about 0.1% colorant. This includes, for example, about 0% to about 6%, about 0.01% to about 5%, and about 0.1% to about 1% colorant.

In some embodiments, the film coating suspension may include at least about 0%, at least abut 0.1%, at least about 0.2%, at least about 0.3%, at least about 0.4%, at least about 0.5%, at least about 0.6%, at least about 0.7%, at least about 0.8%, at least about 0.9%, at least about 1%, and at least about 2% surfactant. The film coating suspension may include less than about 3%, less than about 2%, and less than about 1% surfactant. This includes, for example, about 0% to about 5%, about 0.1% to about 3%, and about 0.5% to about 2% surfactant.

In some embodiments, the film coating suspension may include at least about 0%, at least about 0.1%, at least about 0.5%, at least about 1%, at least about 2%, at least about 3%, at least about 4%, and at least about 5% buffering agent. The film coating suspension may include less than about 10%, less than about 9%, less than about 8%, less than about 7%, less than about 6%, less than about 5%, less than about 4%, less than about 3%, less than about 2%, and less than about 1% buffering agent. This includes, for example, about 0% to about 10%, about 0.1% to about 5%, and about 1% to about 3% buffering agent. In some embodiments, the film coating suspension may include at least about 0.01 M, at least about 0.02 M, at least about 0.03 M, and at least about 0.04 M buffering agent. In some embodiments, the film coating suspension may include less than about 0.1 M, less than about 0.09 M, less than about 0.08 M, less than about 0.07 M, less than about 0.06 M, less than about 0.05 M, and less than about 0.04 M buffering agent. This includes, for example, about 0.01 M to about 0.1 M, and about 0.01 to about 0.05 M buffering agent.

In some embodiments, the film coating suspension may include at least about 30%, at least about 40%, at least about 50%, at least about 60%, at least about 65%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, and at least about 90% solvent. The film coating suspension may include less than about 95%, less than about 90%, less than about 85%, less than about 80%, and less than about 75% solvent. This includes, for example, about 30% to about 95%, about 60% to about 90%, and about 70% to about 85% solvent. The balance of the film coating suspension may comprise solvent (e.g., water).

In an aspect, a dry film coating may be formed on a substrate after application of the film coating suspension to the substrate. In some embodiments, the dry film coating formed on the substrate may contain little or no solvent.

In some embodiments, the dry film coating may include may include at least about 20%, at least about 21%, at least about 22%, at least about 23%, at least about 24%, at least about 25%, at least about 26%, at least about 27%, at least about 28%, at least about 29%, at least about 30%, at least about 35%, and at least about 40% cellulose film former. The dry film coating may include less than about 90%, less than about 80%, less than about 70%, less than about 60%, less than about 55%, less than about 52%, less than about 50%, less than about 45%, less than about 42%, less than about 40%, less than about 35%, and less than about 30% cellulose film former. This includes, for example, about 20% to about 90%, about 25% to about 52%, and about 28% to about 42% cellulose film former. In some embodiments, the cellulose film former may comprise, for example, HPMC and/or CMC.

In another aspect, the disclosure provides a dry film coating. In some embodiments, the dry film coating may include at least about 1%, at least about 2%, at least about 3%, at least about 4%, at least about 5%, at least about 6%, at least about 7%, at least about 8%, at least about 9%, at least about 10%, at least about 15%, and at least about 20% oligofructose fiber. The dry film coating may include less than about 50%, less than about 40%, less than about 30%, less than about 20%, less than about 12%, less than about 11%, less than about 10%, less than about 9%, less than about 8%, less than about 7%, less than about 6%, and less than about 5% oligofructose fiber. This includes, for example, about 1% to about 50%, about 4% to about 12%, and about 4% to about 10% oligofructose fiber. In some embodiments, the oligofructose fiber may comprise, for example, inulin.

In some embodiments, the dry film coating may include at least about 3%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, and at least about 20% plasticizing agent. The dry film coating may include less than about 30%, less than about 25%, less than about 24%, less than about 23%, less than about 22%, less than about 21%, less than about 20%, less than about 19%, and less than about 18% plasticizing agent. This includes, for example, about 3% to about 30%, about 6% to about 25%, and about 10% to about 22% plasticizing agent. In some embodiments, the plasticizing agent may comprise, for example, glycerin, propylene glycol dicaprylate/dicaprate and/or medium chain triglycerides.

In some embodiments, the dry film coating may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% lubricant. The dry film coating may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% lubricant. This includes about 5% to about 35%, about 5% to about 30%, and about 8% to about 30% lubricant.

In some embodiments, the dry film coating may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% slip aid. The dry film coating may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% slip aid. This includes about 5% to about 35%, about 5% to about 30%, and about 8% to about 30% slip aid.

In some embodiments, the dry film coating may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% detackifier. The dry film coating may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% detackifier. This includes about 5% to about 35%, about 5% to about 30%, and about 8% to about 30% detackifier.

In some embodiments, the dry film coating may include at least about 5%, at least about 10%, at least about 15%, at least about 20%, at least about 21%, at least about 22%, at least about 23%, at least about 24%, at least about 25%, at least about 26%, at least about 27%, at least about 28%, at least about 29%, and at least about 30% processing aid. The dry film coating may include less than about 35%, less than about 34%, less than about 33%, less than about 32%, less than about 31%, less than about 30%, less than about 29%, less than about 28%, less than about 27%, less than about 26%, less than about 25%, less than about 20%, and less than about 15% processing aid. This includes about 5% to about 35%, about 5% to about 30%, and about 8% to about 30% processing aid.

In some embodiments, the dry film coating may include about 5% to about 35%, about 5% to about 30%, and about 8% to about 30% processing aid. The dry film coating may include about 5% to about 35%, about 5% to about 30%, and about 8% to about 30% slip aid. The dry film coating may include about 5% to about 35%, about 5% to about 30%, and about 8% to about 30% detackifier. The dry film coating may include about 5% to about 35%, about 5% to about 30%, and about 8% to about 30% lubricant.

In some embodiments, the dry film coating may include at least about 1%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, and at least about 20% opacifier. The dry film coating may include less than about 30%, less than about 25%, less than about 24%, less than about 23%, less than about 22%, less than about 21%, less than about 20%, less than about 15%, and less than about 10% opacifier. This includes, for example, about 1% to about 30%, about 5% to about 25%, and about 5% to about 20% opacifier.

In some embodiments, the dry film coating may include at least about 0.05%, at least about 0.06%, at least about 0.07%, at least about 0.08%, at least about 0.09%, at least about 1%, at least about 2%, at least about 3%, at least about 4%, at least about 5%, at least about 10%, and at least about 15% colorant. The dry film coating may include less than about 30%, less than about 25%, less than about 20%, less than about 15%, less than about 10%, less than about 5%, less than about 1%, and less than about 0.1% colorant. This includes, for example, about 0.05% to about 30%, about 0.05% to about 25%, and about 0.1% to about 20% colorant.

In some embodiments, dry film coating may include at least about 0.1%, at least about 0.5%, at least about 1%, at least about 2%, at least about 3%, at least about 4%, at least about 5%, at least about 6%, at least about 7%, at least about 8%, at least about 9%, and at least about 10% surfactant. The dry film coating may include less than about 10%, less than about 9%, less than about 8%, less than about 7%, less than about 6%, less than about 5%, less than about 4%, less than about 3%, less than about 2%, and less than about 1% surfactant. This includes, for example, about 0.1% to about 10%, about 1% to about 6%, and about 1% to about 4% surfactant.

In some embodiments, the dry film coating may include at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, and at least about 5% buffering agent. The dry film coating may include less than about 10%, less than about 9%, less than about 8%, less than about 7%, less than about 6%, less than about 5%, less than about 4%, less than about 3%, less than about 2%, and less than about 1% buffering agent. This includes, for example, about 0.1% to about 10%, 1% to about 6%, and about 2% to about 5%, about 0.1% to about 0.5%, about 0.1% to about 0.4%, and about 0.1% to about 0.35% buffering agent.

In some embodiments, the disclosed film coating suspension suitably exhibits low viscosity and/or high solution solids content. Thus, embodiments provide a coating suspension that exhibits a low viscosity relative to the amount of solids content. In some embodiments, the disclosed film coating suspensions may include high solution solids content. Suitably, a film coating suspension having high solution solids content may include, for example, at least about 5% solids, at least about 15%, and at least about 20% solution solids. In some embodiments, the disclosed film coating suspensions may have low viscosity. Suitably, film coating suspension having low viscosity may have viscosity of less than about 400 centipoise (cps), less than about 300 cps, less than about 250 cps, less than about 200 cps, less than about 150 cps, and less than about 100 cps. In some embodiments, the disclosed film coating suspensions may have high solution solids content and low viscosity. Suitably, the film coating suspensions may have at least about 5% solids, at least about 15%, and at least about 20% solution solids and viscosity of less than about 400 cps, less than about 300 cps, less than about 250 cps, less than about 200 cps, less than about 150 cps, and less than about 100 cps. In embodiments, the disclosed film coating suspensions may have lower viscosity than a traditional film coating with the same solution solids percentage. In some embodiments, the disclosed film coating suspensions comprise a cellulose film former, an oligofructose fiber, and a plasticizing agent in amounts sufficient to confer a film coating suspension with lower viscosity than a traditional film coating with the same solution solids percentage.

Viscosity may be assessed by any suitable method such as, for example, using a Brookfield viscometer equipped with a UL Adapter Assembly and UL Spindle (available from Brookfield Engineering Labs., Inc.). The film coating suspension or other test sample is poured into a clean graduated cylinder or other sample container, and the spindle is immersed in the sample. After starting the viscometer motor, the speed is adjusted to achieve a percent torque between 50-70%, and the viscosity (cps) of the sample is recorded.

In embodiments, the disclosed dry film coatings may have a high gloss. Suitably, a dry film coating having high gloss may have gloss of at least about 5, at least about 6, at least about 7, at least about 8, at least about 9, at least about 10, at least about 11, at least about 12, at least about 13, at least about 14, at least about 15, at least about 20, or at least about 25 gloss units. This includes, for example, about 5 to about 30 gloss units and about 7 to about 12 gloss units. Gloss of coatings such as the disclosed dry film coatings may be assessed using a Novo-Curve™ Glossmeter (available from Elcometer Instruments Ltd.). The glossmeter is calibrated according to manufacturer's instructions, and a coated tablet is placed over the sample orifice to measure gloss. Each sample can be tested multiple times (e.g., in triplicate) in order to obtain an average gloss reading. In embodiments, the disclosed dry film coatings may exhibit gloss that equals and/or exceeds the loss of a traditional film coating. In some embodiments, the disclosed dry film coatings comprise a cellulose film former, an oligofructose fiber, and a plasticizing agent in amounts sufficient to confer gloss that equals and/or exceeds the gloss of a traditional film coating.

In embodiments, the disclosed dry film coatings may have high slip and/or increase the slip characteristics of a coated substrate relative to an uncoated substrate, or a substrate that comprises a different coating. Suitably, a dry film coating having high slip may have slip of less than about 100, less than about 90, less than about 80, less than about 70, less than about 60, less than about 55, less than about 50, less than about 45, less than about 44, less than about 43, less than about 42, less than about 41, less than about 40, less than about 39, less than about 38, less than about 37, less than about 36, less than about 35, less than about 34, less than about 33, less than about 32, less than about 31, less than about 30, less than about 29, less than about 28, less than about 27, less than about 26, less than about 25, or less than about 20 g tension force. This includes, for example, about 20 g tension force to about 100 g tension force and about 30 g tension force to about 40 g tension force. Slip may be assessed using a TA.TX Texture Analyzer with a vertical friction rig serving as a force arm. The probe height and force may be calibrated and the return force arm positioned 5 mm from the bottom of the container. A non-friction gliding object, such as a piece of paper tissue, may be attached to the vertical probe of the rig using heavy-duty double-sided tape. A tablet or other substrate coated with a coating may be attached to the vertical wall of the rig using heavy-duty double-sided tape. To measure the tension force, a weight (e.g., 100 g) is added to the horizontal plate of the probe, and incremental increases of force are applied to the non-friction gliding object in contact with the coating until the gliding object slips or moves. In embodiments, the disclosed dry film coatings may exhibit slip that equals and/or exceeds the slip of a traditional film coating. In some embodiments, the disclosed dry film coatings comprise a cellulose film former, an oligofructose fiber, and a plasticizing agent in amounts sufficient to confer slip that equals and/or exceeds the slip of a traditional film coating.

In embodiments, the disclosed dry film coatings may exhibit strong adhesion to a substrate. Adhesion of the dry film coatings may be measured using a TA.TX Texture Analyzer (available from Texture Technologies Corp.) equipped with a 25 mm stainless steel cylindrical probe. A round placebo tablet coated with a coating is scored around its hemisphere with a sharp blade and then attached to the top of the flat platform of the texture analyzer using heavy-duty double-sided tape (available from 3M). Another piece of heavy-duty double-sided tape is pressed to the bottom of the cylindrical probe, and the probe is then compressed to 800 g force onto the softgel for 10 seconds. The probe is then pulled away from the softgel at a rate of 1 mm/second, measuring the tension force until either (1) the coating separates from the softgel, or (2) the tape separates from the coating. Where the coating remains on the substrate, the measured force equals the force required to pull the double-sided tape away from the coating, and the adhesion force of the coating to the softgel is thus greater than the measured adhesion force between the tape and the coating. Suitably, a dry film coating having strong adhesion may exhibit an adhesion force between the coating and the placebo tablet of at least about 0.5, at least about 0.6, at least about 0.7, at least about 0.8, at least about 0.9, at least about 1, at least about 1.1, at least about 1.2, at least about 1.3, at least about 1.4, at least about 1.5, at least about 1.6, at least about 1.7, at least about 1.8, at least about 1.9, or at least about 2 g force. This includes, for example, about 0.8 g force to about 1.5 g force and about 1.1 g force to about 1.3 g force.

In embodiments, the disclosed dry film coating compositions, film coating suspensions, and/or dry film coatings may comprise a cellulose film former, an oligofructose fiber, a plasticizing agent, and a processing aid. For example, some embodiments provide dry film coating compositions comprising about 28% to about 42% cellulose film former, about 4% to about 10% oligofructose fiber, about 10% to about 22% plasticizing agent, and about 8% to about 30% processing aid. In another example, some embodiments provide film coating suspensions comprising about 5% to about 10% cellulose film former, about 1% to about 5% oligofructose fiber, about 2% to about 4% plasticizing agent, and about 4% to about 10% processing aid. In yet another example, some embodiments provide dry film coatings comprising about 28% to about 42% cellulose film former, about 4% to about 10% oligofructose fiber, about 10% to about 22% plasticizing agent, and about 8% to about 30% processing aid.

In some embodiments, the disclosed dry film coating compositions, film coating suspensions, and/or dry film coatings may comprise HPMC, inulin, propylene glycol dicaprylate/dicaprate, and talc. In some embodiments, the disclosed dry film coating compositions, film coating suspensions, and/or dry film coatings may comprise HPMC, inulin, medium chain triglycerides, and talc.

The compositions and suspensions described herein can be manufactured using techniques and equipment that are known and commonly used in the art. Equipment known in the industry for standard tablet coating are Thomas Engineering, Inc., and Vector Corporation Hi-Coater® tablet coating systems. Manufacturing steps such as order of component addition, mixing temperatures (heating and/or cooling), mixing time, mixing speed, etc. can be driven by either by formulation or equipment requirements, or both. A number of parameters can be modified during the manufacturing process without substantial effect on the efficacy of the resulting product. The manufacturing processes can further include separate steps for validating the resulting composition (e.g., the total amounts, ratios, and even distribution of components in the composition, etc.).

In an embodiment, the film coating suspension may be formed as follows. Components of a dry film coating composition comprising at least one of a cellulose film former, an oligofructose fiber, a plasticizing agent, a processing aid, a slip aid, a detackifier, a lubricant, an opacifier, a colorant, a surfactant, a buffering agent, and combinations thereof may be mixed with, for example, a plow mixer. If included, one or more plasticizing agents may be added last to the dry film coating composition. Solvent (e.g., water) may be added to a mixing tank equipped with a high-shear overhead mixer and brought to a medium vortex. The dry film coating composition may be added into the medium vortex, and mixing may continue for at least about 30 minutes and/or until the suspension achieves a smooth consistency with no visible lumps.

The application techniques are described below. In some embodiments, a coating pan may be charged with a substrate such as, for example, capsules, tablets, and/or softgels. In some embodiments, the bed may be warmed to about 33° C. to about 40° C. The processing parameters may be as set forth below.

The film coating suspensions may, at a suitable concentration which is spraying system dependent, be sprayed using commercially available equipment to form films on substrates. In some embodiments, the film coating suspension may be applied to a substrate by loading substrate into a vented coating pan, such as, for example, a 15-inch, 24-inch, 48-inch, or 60-inch side-vented coating pan. The inlet temperature may be at least about 45° C., at least about 50° C., at least about 55° C., at least about 58° C., at least about 60° C., at least about 65° C., and at least about 70° C. The inlet temperature may be less than about 75° C., less than about 70° C., less than about 65° C., and less than about 60. This includes, for example, about 50° C. to about 75° C., about 50 to about 65° C., and about 55° C. to about 75° C. The outlet temperature may be at least about 32° C., at least about 35° C., at least about 40° C., and at least about 45° C. The outlet temperature may be less than about 55° C., less than about 50° C., less than about 50° C., and less than about 45° C. This includes, for example, about 32° C. to about 55° C., about 35° C. to about 45° C., and about 40° C. to about 50° C. The atomizing air pressure may be at least about 20 psi, at least about 21 psi, at least about 25 psi, at least about 30 psi, at least about 35 psi, at least about 40 psi, at least about 45 psi, at least about 50 psi, and at least about 55 psi. The atomizing air pressure may be less than about 75 psi, less than about 70 psi, less than about 65 psi, less than about 60 psi, less than about 55 psi, less than about 50 psi, less than about 40 psi, and less than about 30 psi. This includes, for example, about 20 to about 75 psi, about 21 to about 23 psi, about 25 to about 30 psi, about 50 to about 55 psi, and about 50 to about 70 psi. The coating time may be from about 5 minutes to about 3 hours. The film coating suspension can be allowed to dry, forming a dry film coating on the substrate. Exemplary coating parameters are provided in Table 1.

TABLE 1
Exemplary coating parameters.

| Pan Size | 15 inch | 24 inch | 48 inch | 60 inch |
|---|---|---|---|---|
| Air volume (cfm) | 280-320 | 440-520 | 2200-2400 | 3800-4800 |
| Inlet temp. (° C.) | 50-65 | 50-65 | 55-75 | 55-75 |
| Outlet temp. (° C.) | 35-45 | 35-45 | 40-50 | 40-50 |
| Bed temp. (° C.) | 33-44 | 33-44 | 35-47 | 35-47 |
| Pre-warm temp. (° C.) | 30-40 | 30-40 | 30-40 | 30-45 |
| Spray rate (g/min) | 15-20 | 20-60 | 450-650 | 600-1000 |
| Atomizing air pressure (psi) | 21-23 | 25-30 | 50-55 | 50-70 |
| Pattern air pressure (psi) | 25 | 35 | 50-60 | 50-75 |
| No. of guns | 1 | 2 | 3-4 | 4-6 |
| Pan speed (rpm) | 15-20 | 12-15 | 5-10 | 4-6 |
| Pan charge weight (kg) | 1-3 | 15-20 | 120-200 | 250-350 |

The dry film coatings may be flexible with tensile strength. The dry film coating may be consistent batch-to-batch, may meet current FDA regulations for dietary supplements, may be robust (easy to use and prepare), and may coat various surfaces (softgels, capsules, tablets, gelatin, vegetable, etc). The dry film coating may be cost effective and economical. Substrates coated with the disclosed dry film coatings may pass an immediate release disintegration test, such as, for example, USP32/NF27 S2, Chapter 2040 (Disintegration and Dissolution of Dietary Supplements), Chapter 701 (Disintegration) testing criteria. In some embodiments, the dry film coatings can be GRAS (Generally Recognized as Safe) and may be vegetarian. The dry film coatings may be able to be applied at a fast rate and broad temperature while providing good film adhesion and flexibility.

The dry film coating compositions may be used in food, pharmaceutical or nutraceutical applications intended for use in mammals, including, without limitation, rodents, canines, felines, non-human primates, ungulates, and humans. They can be used to coat pharmaceutical or non-pharmaceutical dosage units.

### EXAMPLES

Exemplary embodiments of the disclosure are provided in the following examples. The following examples are provided merely to illustrate certain embodiments of the disclosure and to assist one of ordinary skill in making and using the same, are not to be interpreted to limit the scope of the disclosure or the appended claims.

### Materials.

Inulin preparations including Orafti® P95 and Orafti® HSI (available from BENEO, Inc.); Miglyol® 840 (available from Sasol GmbH) and Neobee® M-20 (available from Stepan Co.) propylene glycol dicaprylate/dicaprate; Plasacryl™ aqueous emulsion containing glyceryl monostearate and triethyl citrate; MyVacet™ 9-45 acetylated monglyceride (available from Eastman Chemical Products, Inc.); Neobee® M-5 medium chain triglycerides from fractionated coconut oil (available from Stepan Co.). HPMC preparations including HPMC 3, HPMC 5, HPMC 6, and HPMC 15, wherein the numbers 3, 5, 6, and 15 indicate the HPMC preparation's viscosity in 1% aqueous solution (i.e., “HPMC 3” indicates an HPMC preparation that exhibits a viscosity of 3 cps when mixed with water to make a 1% (w/w) HPMC solution). Commercially available examples include Spectracel™ 3, 5, 6, and 15 (available from Sensient Technologies).

### Comparative Example 1

### Traditional HPMC Coating Formulations

A traditional HPMC coating composition and traditional HPMC coating suspension were prepared according to Table 2.

TABLE 2
Traditional HPMC Coating Formulations

| | % of Coating | % of Dry Coating |
|---|---|---|
| Material | Suspension | Composition |
| HPMC 6 | 11 | 55 |
| titanium dioxide | 4 | 20 |
| talc | 4 | 20 |
| triacetin | 1 | 5 |
| water | 80 | 0 |
| Total solids by weight | 20% | 100% |

HPMC, titanium dioxide, talc, and triacetin were blended in the mix chamber of a plow mixer (Littleford; Florence, Ky.). To the chamber, triacetin was added to form traditional HPMC dry film coating composition. The traditional HPMC dry film coating composition was blended for an additional minute.

Water was added to the mix chamber of a mixing tank equipped with an overhead mixer attached with a mixing blade not less than ⅓ the diameter of the mixing tank (Littleford; Florence, Ky.). The traditional HPMC coating composition was added to the vortex and mixed to afford a homogenous traditional HPMC coating suspension.

### Example 1

A dry film coating composition and film coating suspension were prepared according to Table 3.

TABLE 3
Dry Film Coating Composition and Film Coating Suspension

| | % of Film | % of Dry |
|---|---|---|
| | Coating | Film Coating |
| Material | Suspension | Composition |
| HPMC 6 | 6 | 28.6 |
| Inulin (Orafti ® P95) | 1 | 4.8 |
| titanium dioxide | 4 | 19 |
| talc | 6 | 28.6 |
| propylene glycol | 4 | 19 |
| dicaprylate/dicaprate | | |
| water | 79 | 0 |
| Total solids by weight | 21% | 100% |

HPMC, inulin, titanium dioxide, and talc were blended in the mix chamber of a plow mixer (Littleford; Florence, Ky.). To the chamber, propylene glycol dicaprylate/dicaprate was added to form the dry film coating composition. The dry film coating composition was blended for an additional minute.

Water was added to the mix chamber of a mixing tank equipped with an overhead mixer attached with a mixing blade not less than ⅓ the diameter of the mixing tank (Littleford; Florence, Ky.). The dry film coating composition was added to the vortex and mixed to afford a homogenous film coating suspension.

### Example 2

A dry film coating composition and film coating suspension were prepared according to Table 4.

TABLE 4
Dry Film Coating Composition and Film Coating Suspension

| | % of Film | % of Dry |
|---|---|---|
| | Coating | Film Coating |
| Material | Suspension | Composition |
| HPMC 6 | 6 | 27.3 |
| Sodium carboxymethyl | 1 | 4.5 |
| cellulose | | |
| Inulin (Orafti ® P95) | 1 | 4.5 |
| titanium dioxide | 4 | 18.2 |
| talc | 6 | 27.3 |
| propylene glycol | 4 | 18.2 |
| dicaprylate/dicaprate | | |
| Water | 78 | 0 |
| Total solids by weight | 22% | 100% |

HPMC, sodium carboxymethyl cellulose, inulin, titanium dioxide, and talc were blended in the mix chamber of a plow mixer (Littleford; Florence, Ky.). To the chamber, propylene glycol dicaprylate/dicaprate was added to form the dry film coating composition. The dry film coating composition was blended for an additional minute.

Water was added to the mix chamber of a mixing tank equipped with an overhead mixer attached with a mixing blade not less than ⅓ the diameter of the mixing tank (Littleford; Florence, Ky.). The dry film coating composition was added to the vortex and mixed to afford a homogenous film coating suspension.

The following Examples were manufactured using the same or similar methods as described above.

### Example 3

| | % of Film | % of Dry |
|---|---|---|
| | Coating | Film Coating |
| Material | Suspension | Composition |
| HPMC 6 | 5.71 | 28.6% |
| Inulin (Orafti P95) | 0.95 | 4.8% |
| Titanium Dioxide | 3.81 | 19.0% |
| Talc | 5.71 | 28.6% |
| Propylene Glycol | 3.81 | 19.0% |
| Dicaprylate/Dicaprate | | |
| Water | 80.0 | 0% |
| Total solids by weight | 20.0% | 100% |

### Example 4

| | % of Film | % of Dry |
|---|---|---|
| | Coating | Film Coating |
| Material | Suspension | Composition |
| HPMC 6 | 5.45 | 27.3% |
| CMC | 0.91 | 4.5% |
| Inulin (Orafti P95) | 0.91 | 4.5% |
| Titanium Dioxide | 3.63 | 18.2% |
| Talc | 5.45 | 27.3% |
| Propylene Glycol | 3.63 | 18.2% |
| Dicaprylate/Dicaprate | | |
| Water | 80.0 | 0% |
| Total solids by weight | 20.0% | 100% |

### Example 5

| | % of Film | |
|---|---|---|
| | Coating | |
| Material | Suspension | Quantity (g) |
| HPMC 3 | 6 | 12 |
| CMC | 1 | 2 |
| Inulin (Orafti P95) | 1 | 2 |
| Titanium Dioxide | 4 | 8 |
| Talc | 6 | 12 |
| Propylene Glycol | 4 | 8 |
| Dicaprylate/dicaprate (Miglyol 840) | | |
| Water | 78 | 156 |
| Total solids by weight | 22% | |

### Example 6

| | % of Film | |
|---|---|---|
| | Coating | |
| Material | Suspension | Quantity (g) |
| HPMC 3 | 6 | 12 |
| Inulin (Orafti P95) | 1 | 2 |
| Titanium Dioxide | 4 | 8 |
| Talc | 6 | 12 |
| Propylene Glycol | 4 | 8 |
| Dicaprylate/dicaprate (Miglyol 840) | | |
| Water | 79 | 158 |
| Total solids by weight | 21% | |

### Example 7

| | % of Film | |
|---|---|---|
| | Coating | |
| Material | Suspension | Quantity (g) |
| HPMC 6 | 6 | 12 |
| HPMC (Spectracel 15 CP) | 4 | 8 |
| CMC | 1 | 2 |
| Inulin (Orafti HSI) | 5 | 10 |
| Titanium Dioxide | 4 | 8 |
| Propylene Glycol | 5 | 10 |
| Dicaprylate/dicaprate (Miglyol 840) | | |
| Water | 75 | 150 |
| Total solids by weight | 25% | |

### Example 8

| | % of Film | |
|---|---|---|
| | Coating | |
| Material | Suspension | Quantity (g) |
| HPMC 5 | 7 | 14 |
| CMC | 1 | 2 |
| Inulin (Orafti HSI) | 4.1 | 8.2 |
| Titanium Dioxide | 3.5 | 7 |
| Propylene Glycol | 4.4 | 8.8 |
| Dicaprylate/dicaprate (Miglyol 840) | | |
| Water | 80 | 160 |
| Total solids by weight | 20% | |

### Example 9

| | % of Film | |
|---|---|---|
| | Coating | |
| Material | Suspension | Quantity (g) |
| HPMC 3 | 6 | 12 |
| CMC | 1 | 2 |
| Inulin (Orafti HSI) | 5 | 10 |
| Titanium Dioxide | 3.5 | 7 |
| Propylene Glycol | 4.5 | 9 |
| Dicaprylate/dicaprate (Miglyol 840) | | |
| Water | 80 | 160 |
| Total solids by weight | 20% | |

### Example 10

| | % of Film | |
|---|---|---|
| | Coating | |
| Material | Suspension | Quantity (g) |
| Inulin (Orafti HSI) | 10 | 20 |
| Titanium Dioxide | 4 | 8 |
| Talc | 6 | 12 |
| Propylene Glycol | 3 | 6 |
| Dicaprylate/dicaprate (Miglyol 840) | | |
| Water | 77 | 154 |
| Total solids by weight | 23% | |

### Example 11

| | % of Film | |
|---|---|---|
| | Coating | |
| Material | Suspension | Quantity (g) |
| HPMC 6 | 6 | 12 |
| Inulin (Orafti P95) | 1 | 2 |
| Titanium Dioxide | 4 | 8 |
| Talc | 6 | 12 |
| Propylene Glycol | 4 | 8 |
| Dicaprylate/dicaprate (Neobee M-20) | | |
| Water | 79 | 158 |
| Total solids by weight | 21% | |

### Example 12

| | % of Film | |
|---|---|---|
| | Coating | |
| Material | Suspension | Quantity (g) |
| HPMC 6 | 6 | 12 |
| Inulin (Orafti P95) | 1.5 | 3 |
| Titanium Dioxide | 4 | 8 |
| Talc | 6 | 12 |
| Propylene Glycol | 4 | 8 |
| Dicaprylate/dicaprate (Miglyol 840) | | |
| Water | 78.5 | 157 |
| Total solids by weight | 21.5% | |

### Example 13

| | % of Film | |
|---|---|---|
| | Coating | |
| Material | Suspension | Quantity (g) |
| HPMC 6 | 6 | 12 |
| Inulin (Orafti P95) | 0.5 | 1 |
| Titanium Dioxide | 4 | 8 |
| Talc | 6 | 12 |
| Propylene Glycol | 4 | 8 |
| Dicaprylate/dicaprate (Miglyol 840) | | |
| Water | 79.5 | 159 |
| Total solids by weight | 20.5% | |

### Example 14

| | % of Film | |
|---|---|---|
| | Coating | |
| Material | Suspension | Quantity (g) |
| HPMC 3 | 8.9 | 17.8 |
| Titanium Dioxide | 5.3 | 10.6 |
| Glyceryl monostearate (Plasacryl) | 5.7 | 11.4 |
| Water | 80 | 160 |
| Total solids by weight | 20% | |

### Example 15

| | % of Dry |
|---|---|
| | Film Coating |
| Material | Composition |
| HPMC 6 | 52.2 |
| Inulin (Orafti P95) | 4.2 |
| Titanium Dioxide | 3 |
| Talc | 9.3 |
| Propylene Glycol | 17 |
| Dicaprylate/dicaprate (Miglyol 840) | |
| FD&C Red 40 (14-16%) | 0.3 |
| Sensipearl Bright Silver | 14 |
| Total | 100% |

### Example 16

| | % of Dry | |
|---|---|---|
| | Film Coating | |
| Material | Composition | Quantity (g) |
| HPMC 6 | 48.3 | 19.32 |
| Inulin (Orafti P95) | 4.2 | 1.68 |
| Titanium Dioxide | 3 | 1.2 |
| Talc | 9.3 | 3.72 |
| Propylene Glycol | 17 | 6.8 |
| Dicaprylate/dicaprate (Miglyol 840) | | |
| FD&C Al Lk Red 40 (35-42%) | 3.3 | 1.32 |
| FD&C Al Lk Blue #2 (12-14%) | 0.2 | 0.08 |
| FD&C Red 40 powder | 0.7 | 0.28 |
| Sensipearl Bright Silver | 14 | 5.6 |
| Total | 100% | 40 g |

### Example 17

| | % of Dry | |
|---|---|---|
| | Film Coating | |
| Material | Composition | Quantity (g) |
| HPMC 6 | 28.29 | 14.145 |
| Inulin (Orafti P95) | 4.75 | 2.375 |
| Titanium Dioxide | 18.79 | 9.395 |
| Talc | 28.29 | 14.145 |
| Propylene Glycol | 14.39 | 7.195 |
| Dicaprylate/dicaprate (Miglyol 840) | | |
| Acetylated monoglyceride (MyVacet 9- | 4.4 | 2.2 |
| 45) | | |
| Blue 2 Al Lake (35-42%) | 0.18 | 0.09 |
| Blue 2 Al Lake (12-14%) | 0.91 | 0.455 |
| Total | 100% | 50 g |

### Example 18

| | % of Dry | |
|---|---|---|
| | Film Coating | |
| Material | Composition | Quantity (g) |
| HPMC 6 | 28.29 | 56.58 |
| Inulin (Orafti P95) | 4.75 | 29.5 |
| Titanium Dioxide | 18.79 | 37.58 |
| Talc | 28.33 | 56.66 |
| Propylene Glycol | 14.75 | 29.5 |
| Dicaprylate/dicaprate (Miglyol 840) | | |
| Blue 2 Al Lake (35-42%) | 0.18 | .36 |
| Blue 2 Al Lake (12-14%) | 0.91 | 1.82 |
| Water | 4 | 8 |
| Total | 100% | 200 g |

### Example 19

| | % of Dry | |
|---|---|---|
| | Film Coating | |
| Material | Composition | Quantity (g) |
| HPMC 6 | 28.29 | 14.145 |
| Inulin (Orafti P95) | 4.75 | 2.375 |
| Titanium Dioxide | 18.79 | 9.395 |
| Talc | 28.33 | 14.165 |
| Medium Chain Triglycerides (Neobee | 14.75 | 7.375 |
| M-5) | | |
| Blue 1 Al Lake (11-13%) | 0.91 | 0.455 |
| Yellow 5 Al Lake (14-16%) | 0.18 | 0.09 |
| Water | 4 | 2 |
| Total | 100% | 50 g |

### Example 20

| | % of Dry | |
|---|---|---|
| | Film Coating | |
| Material | Composition | Quantity (g) |
| HPMC 6 | 28.3 | 14.15 |
| Inulin (Orafti P95) | 4.7 | 2.35 |
| Titanium Dioxide | 19.72 | 9.86 |
| Talc | 28.3 | 14.15 |
| Propylene Glycol | 14.75 | 7.375 |
| Dicaprylate/dicaprate (Miglyol 840) | | |
| FD&C Yellow 6 Al Lk (17-19%) | 0.23 | 0.115 |
| Water | 4 | 2 |
| Total | 100% | 50 g |

### Example 21

| | % of Dry | |
|---|---|---|
| | Film Coating | |
| Material | Composition | Quantity (g) |
| HPMC 6 | 28.3 | 14.15 |
| Inulin (Orafti P95) | 4.7 | 2.35 |
| Titanium Dioxide | 19.72 | 9.86 |
| Talc | 28.3 | 14.15 |
| Medium Chain Triglycerides | 14.75 | 7.375 |
| FD&C Yellow 6 Al Lk (17-19%) | 0.23 | 0.115 |
| Water | 4 | 2 |
| Total | 100% | 50 g |

### Example 22

| | % of Dry | |
|---|---|---|
| | Film Coating | |
| Material | Composition | Quantity (g) |
| HPMC 6 | 28.3 | 14.15 |
| Inulin (Orafti P95) | 4.7 | 2.35 |
| Titanium Dioxide | 19.8 | 9.9 |
| Talc | 28.2 | 14.1 |
| Propylene Glycol | 14.75 | 7.375 |
| Dicaprylate/dicaprate (Miglyol 840) | | |
| FD&C Yellow 6 Al Lk (17-19%) | 0.25 | 0.125 |
| Water | 4 | 2 |
| Total | 100% | 50 g |

### Example 23

| | % of Dry | |
|---|---|---|
| | Film Coating | |
| Material | Composition | Quantity (g) |
| HPMC 6 | 28.67 | 14.335 |
| Inulin (Orafti P95) | 4.7 | 2.35 |
| Talc | 28.3 | 14.15 |
| Propylene Glycol | 14.75 | 7.375 |
| Dicaprylate/dicaprate (Miglyol 840) | | |
| Sensipearl Bright Silver | 10 | 5 |
| FD&C Red 40 Al Lk (35-42%) | 9.2 | 4.6 |
| FD&C Yellow 6 Al Lk (17-19%) | 0.38 | 0.19 |
| Water | 4 | 2 |
| Total | 100% | 50 g |

### Example 24

| | % of Dry | |
|---|---|---|
| | Film Coating | |
| Material | Composition | Quantity (g) |
| HPMC 5 | 51.2 | 25.6 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 2 | 1 |
| Purple Sweet Potato | 2 | 1 |
| Water | 4 | 2 |
| Total | 100% | 50 g |

### Example 25

| | % of Dry | |
|---|---|---|
| | Film Coating | |
| Material | Composition | Quantity (g) |
| HPMC 5 | 51 | 25.5 |
| Inulin (Orafti P95) | 4.7 | 2.35 |
| Titanium Dioxide | 1 | 0.5 |
| Talc | 21 | 10.5 |
| Medium Chain Triglycerides (Neobee | 14 | 7 |
| M-5) | | |
| Citric Acid | 2 | 1 |
| Red Sweet Potato | 2 | 1 |
| Caramel | 0.3 | 0.15 |
| Water | 4 | 2 |
| Total | 100% | 50 g |

### Example 26

| | % of Dry | |
|---|---|---|
| | Film Coating | |
| Material | Composition | Quantity (g) |
| HPMC 5 | 49.2 | 24.6 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 2 | 1 |
| Red Sweet Potato | 4 | 2 |
| Water | 4 | 2 |
| Total | 100% | 50 g |

### Example 27

| | % of Dry | |
|---|---|---|
| | Film Coating | |
| Material | Composition | Quantity (g) |
| HPMC 5 | 52.55 | 26.275 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 0.65 | 0.325 |
| Purple Sweet Potato | 2 | 1 |
| Water | 4 | 2 |
| Total | 100% | 50 g |

### Example 28

| | % of Dry | |
|---|---|---|
| | Film Coating | |
| Material | Composition | Quantity (g) |
| HPMC 5 | 52.5 | 26.25 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 0.7 | 0.35 |
| Purple Sweet Potato | 2 | 1 |
| Water | 4 | 2 |
| Total | 100% | 50 g |

### Example 29

| | % of Dry | |
|---|---|---|
| | Film Coating | |
| Material | Composition | Quantity (g) |
| HPMC 5 | 52.21 | 26.105 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 0.65 | 0.325 |
| Sodium Citrate (anhydrous) | 0.34 | 0.17 |
| Purple Sweet Potato | 2 | 1 |
| Water | 4 | 2 |
| Total | 100% | 50 g |

### Example 30

| | % of Dry | |
|---|---|---|
| | Film Coating | |
| Material | Composition | Quantity (g) |
| HPMC 5 | 52.424 | 26.212 |
| Inulin (Orafti P95) | 4.8 | 2.4 |
| Titanium Dioxide | 1 | 0.5 |
| Talc | 21 | 10.5 |
| Medium Chain Triglycerides (Neobee | 14 | 7 |
| M-5) | | |
| Citric Acid | 0.65 | 0.325 |
| Sodium Citrate (anhydrous) | 0.126 | 0.063 |
| Purple Sweet Potato | 2 | 1 |
| Water | 4 | 2 |
| Total | 100% | 50 g |

### Example 31

| | % of Film | |
|---|---|---|
| | Coating | |
| Material | Suspension | Quantity (g) |
| HPMC 6 | 7 | 14 |
| Inulin (Orafti P95) | 6 | 12 |
| Propylene Glycol | 3 | 6 |
| Dicaprylate/dicaprate (Miglyol 840) | | |
| Water | 84 | 168 |
| Total | 100% | 200 g |

| | |
|---|---|
| viscosity | 217 cps |
| % solution solids | 16% |

### Example 32

| | % of Film | |
|---|---|---|
| | Coating | |
| Material | Suspension | Quantity (g) |
| HPMC 6 | 9.6 | 28.8 |
| Inulin (Orafti P95) | 0.6 | 1.8 |
| Propylene Glycol | 1.8 | 5.4 |
| Dicaprylate/dicaprate (Miglyol 840) | | |
| Water | 88 | 264 |
| Total | 100% | 300 g |

| | |
|---|---|
| viscosity | 304.9 cps |
| % solution solids | 12% |

### Example 33

| | % of Film | |
|---|---|---|
| | Coating | |
| Material | Suspension | Quantity (g) |
| HPMC 6 | 8.3 | 16.6 |
| Inulin (Orafti P95) | 0.5 | 1 |
| Propylene Glycol | 1.2 | 2.4 |
| Dicaprylate/dicaprate (Miglyol 840) | | |
| Water | 90 | 180 |
| Total | 100% | 200 g |

| | |
|---|---|
| viscosity | 264.4 cps |
| % solution solids | 10% |

### Example 34

| | % of Film | |
|---|---|---|
| | Coating | |
| Material | Suspension | Quantity (g) |
| HPMC 6 | 8.3 | 16.6 |
| Inulin (Orafti P95) | 0.5 | 1 |
| Medium Chain Triglycerides (Neobee | 1.2 | 2.4 |
| M-5) | | |
| Water | 90 | 180 |
| Total | 100% | 200 g |

| | |
|---|---|
| viscosity | 248.3 cps |
| % solution solids | 10% |

### Example 35

| | % of Film | |
|---|---|---|
| | Coating | |
| Material | Suspension | Quantity (g) |
| HPMC 6 | 8.3 | 16.6 |
| Inulin (Orafti P95) | 0.5 | 1 |
| Glycerin | 1.2 | 2.4 |
| Water | 90 | 180 |
| Total | 100% | 200 g |

| | |
|---|---|
| viscosity | 350.9 cps |
| % solution solids | 10% |

### Example 36

| | % of Film | |
|---|---|---|
| | Coating | |
| Material | Suspension | Quantity (g) |
| HPMC 6 | 8 | 16 |
| Inulin (Orafti HSI) | 4 | 8 |
| Medium Chain Triglycerides (Neobee | 2.5 | 5 |
| M-5) | | |
| Water | 85.5 | 171 |
| Total | 100% | 200 g |

| | |
|---|---|
| viscosity | 282.4 cps |
| % solution solids | 14.5% |

### Example 37

| | % of Film | |
|---|---|---|
| | Coating | |
| Material | Suspension | Quantity (g) |
| HPMC 6 | 9.96 | 19.9 |
| Inulin (Orafti P95) | 0.6 | 1.2 |
| Medium Chain Triglycerides (Neobee | 1.44 | 2.9 |
| M-5) | | |
| Water | 88 | 176 |
| Total | 100% | 200 g |

| | |
|---|---|
| % solution solids | 12% |

### Example 38

| | % of Film | |
|---|---|---|
| | Coating | |
| Material | Suspension | Quantity (g) |
| HPMC | 8 | 16 |
| β-carotene | 0.13 | 0.3 |
| Water | 91.9 | 183.8 |
| Total | 100% | 200 g |

| | |
|---|---|
| % solution solids | 8.1% |

### Example 39

| | % of Film | |
|---|---|---|
| | Coating | |
| Material | Suspension | Quantity (g) |
| HPMC 6 | 8 | 16 |
| Inulin | 1 | 2 |
| Medium Chain Triglycerides | 3.2 | 6.4 |
| Titanium Dioxide | 3 | 6 |
| Talc | 4.8 | 9.6 |
| Water | 80 | 160 |
| Total | 100% | 200 g |

| | |
|---|---|
| viscosity | 205 cps |
| % solution solids | 20% |

### Example 40

| | % of Dry | |
|---|---|---|
| | Film Coating | |
| Material | Composition | Quantity (g) |
| HPMC 6 | 26.92 | 26.92 |
| Inulin (Orafti P95) | 8.25 | 8.25 |
| Titanium Dioxide | 17.63 | 17.63 |
| Talc | 22.2 | 22.2 |
| Propylene Glycol | 20 | 20 |
| Dicaprylate/dicaprate (Miglyol 840) | | |
| Light Yellow Preblend | 1 | 1 |
| Water | 4 | 4 |
| Total | 100% | 100 g |

### Example 41

| | % of Dry | |
|---|---|---|
| | Film Coating | |
| Material | Composition | Quantity (g) |
| HPMC 6 | 26.92 | 26.92 |
| Inulin (Orafti P95) | 8.25 | 8.25 |
| Titanium Dioxide | 17.63 | 17.63 |
| Talc | 22.2 | 22.2 |
| Propylene Glycol | 20 | 20 |
| Dicaprylate/dicaprate (Miglyol 840) | | |
| Yellow 6 Lake | 1 | 1 |
| Water | 4 | 4 |
| Total | 100% | 100 g |

### Example 42

| | % of Dry | |
|---|---|---|
| | Film Coating | |
| Material | Composition | Quantity (g) |
| HPMC 6 | 28.55 | 28.55 |
| Inulin (Orafti P95) | 8.25 | 8.25 |
| Titanium Dioxide | 14 | 14 |
| Talc | 21.2 | 21.2 |
| Medium Chain Triglycerides | 20 | 20 |
| Yellow 6 Lake | 1 | 1 |
| Riboflavin | 3 | 3 |
| Water | 4 | 4 |
| Total | 100% | 100 g |

1. A dry film coating composition comprising a cellulose film former, an oligofructose fiber, a plasticizing agent, and a processing aid.

2. The dry film coating composition of claim 1, wherein the cellulose film former comprises hydroxypropyl methyl cellulose.

3. The dry film coating composition of claim 1, wherein the oligofructose fiber comprises inulin.

4. The dry film coating composition of claim 1, wherein the plasticizing agent comprises propylene glycol dicaprylate/dicaprate, medium chain triglycerides or a combination thereof.

5. (canceled)

6. The dry film coating composition of claim 1, wherein the processing aid comprises talc.

7. The dry film coating composition of claim 1, further comprising a colorant.

8. The dry film coating composition of claim 1, further comprising a buffering agent.

9. A film coating suspension comprising the dry film coating composition of claim 1 and a solvent.

10-15. (canceled)

16. The film coating suspension of claim 9, wherein the solvent comprises water.

17. The film coating suspension of claim 9, wherein the film coating suspension comprises (by weight) at least about 20% solids.

18. The film coating suspension of claim 9, wherein the film coating suspension has a viscosity of about 100 cps to about 500 cps.

19. A substrate coated with a dry film coating, the dry film coating comprising a cellulose film former, an oligofructose fiber, a plasticizing agent, and a processing aid.

20. The substrate coated with the dry film coating of claim 19, wherein the cellulose film former comprises hydroxypropyl methyl cellulose.

21. The substrate coated with the dry film coating of claim 19, wherein the oligofructose fiber comprises inulin.

22. The substrate coated with the dry film coating of claim 19, wherein the plasticizing agent comprises propylene glycol dicaprylate/dicaprate, medium chain triglycerides or a combination thereof.

23. (canceled)

24. The substrate coated with the dry film coating of claim 19, wherein the processing aid comprises talc.

25. The substrate coated with the dry film coating of claim 19, further comprising a colorant.

26. The substrate coated with the dry film coating of claim 19, wherein the substrate comprises a nutritional supplement, a pharmaceutical, a tablets, a capsule, a softgel, a granule, or a seed.

27. A method of coating a substrate comprising applying the film coating suspension of claim 9 to a substrate to form a dry film coating thereon.

28-30. (canceled)

31. The method of claim 27, wherein the applying step comprises an outlet temperature of about 33° C. to about 52° C.

32. (canceled)
